(19) United States
(12) Patent Application Publication
(10) Pub. No.: US 2008/0178241 A1
(43) Pub. Date: Jul. 24, 2008

(54) System and method for viewing video episodes

(75) Inventor: Christopher Gilboy, Freehold, NJ (US)

Correspondence Address: SCHWEGMAN, LUNDBERG & WOESSNER, P.A., P.O. BOX 2938, MINNEAPOLIS, MN, 55402, US

(73) Assignee: AT&T Knowledge Ventures, L.P.

(21) Appl. No.: 11/655,648

(22) Filed: Jan. 18, 2007

(51) Int. Cl. H04N 7/173

(52) U.S. Cl. 725/114; 725/131

(57) ABSTRACT

A system and method relates to the use of a viewing history of a set of related and sequential video episodes to determine a video episode to be played on an video receiving unit.

### TECHNICAL FIELD

Various embodiments relate to video broadcasts, and in an embodiment, but not by way of limitation, to a system and method for viewing video episodes.

### BACKGROUND

Mobile phones, Personal Digital Assistants (PDAs), and other hand held personal communication devices have become ubiquitous. These devices have progressed from simple communication and data processing devices to devices that can receive, process, and send video data. The additional video ability of such devices has created a need of improved systems and methods to handle such video data.

### BRIEF DESCRIPTION OF THE DRAWINGS

FIG. 1 illustrates an example embodiment of a system for the broadcasting of video episodes to a personal communication device.

FIG. 2 illustrates an example embodiment of a process to deliver video episodes to a personal communication device.

FIG. 3 illustrates another example embodiment of a process to deliver video episodes to a personal communication device.

FIG. 4 illustrates an example embodiment of an architecture that may be used in connection with one or more embodiments.

### DETAILED DESCRIPTION

In an embodiment, a video server is configured to receive from a video receiving unit such as a Set Top Box (STB) or a personal wireless mobile communication device (such as a mobile phone, a personal digital assistant (PDA), a palmtop device, or a lap top computer) a request to transmit a video episode. The video server determines, from a viewing history, the video episode to transmit to the video receiving unit, and then transmits the video episode to the video receiving unit. The viewing history is updated as a function of the video episode transmitted.

In another embodiment, a video receiving unit is configured to use a viewing history to determine a video episode that is to be played on the video receiving unit. The video receiver sends to a video server a request to transmit the video episode to the video receiving unit.

In another embodiment, a process includes the steps of using a viewing history to determine a video episode to be played on an video receiving unit, and sending to a video server a request to transmit the video episode to the video receiving unit.

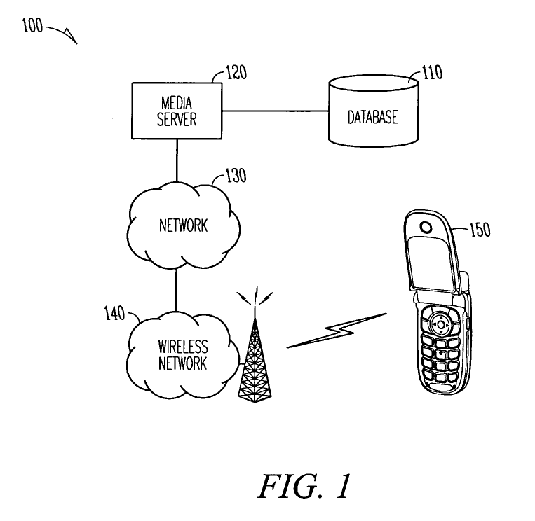

FIG. 1 illustrates an example embodiment of a system 100 for the delivery of video data to a device. In an embodiment, the video data includes episodic video data. In another embodiment, the device is a mobile or hand-held device. As illustrated in FIG. 1, the system 100 may include a database 110, a server 120, a network 130, a wireless network 140, and a device 150. The database 110 may include related video episodes that have a chronological sequence to them. The server 120 may be programmed to retrieve one or more episodes from the database 110, and transmit the one or more video episodes over the network 130. In an embodiment, the network 130 is the Internet, and the video data is transmitted over the Internet using the Internet Protocol (IP). In embodiments in which the device 150 is a mobile device, the device 150 is coupled to the network 130 via the wireless network 140. The server 120 may be an Internet Protocol Television (IPTV) server, and the device 150, which can also be referred to as a video receiving unit, may be an IPTV set top box (STB).

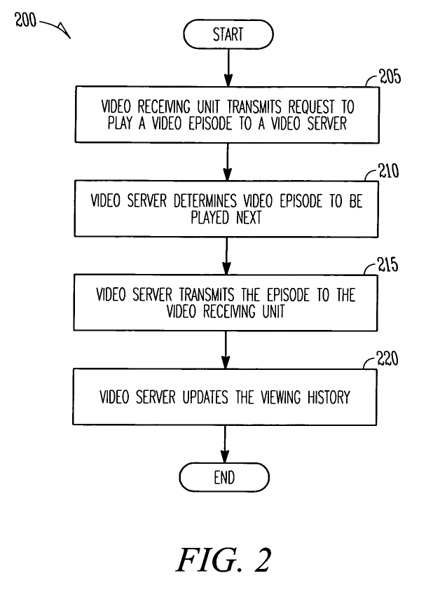

FIG. 2 illustrates an example embodiment of a process 200 that determines which video episode, among a plurality of video episodes, is to be played next on a video receiving unit. At 205, a video receiving unit transmits to a video server a request to view a video episode. The video receiving unit can be any such unit now known or later developed in the art, including both mobile and non-mobile video receiving devices. In an embodiment, the requested video episode is one of a plurality of sequential episodes. In another embodiment, the user of the video receiving unit does not need to know the last episode in the sequence that was viewed, and/or the next video in the sequence to be viewed. At 210, the video server determines the next video episode in the sequence of video episodes to be viewed. In an embodiment, the server determines this by querying a viewing history associated with this video receiving unit. In an embodiment, the user of the video receiving unit enters a user code. In this embodiment, more than one user can benefit from their personal viewing histories using the same video receiving unit. At 215, after the determination of the next video episode to be viewed on the video receiving unit, the video server transmits the episode to the video receiving unit. At 220, the video server updates the viewing history associated with the video receiving unit. In an embodiment, the video server does not update the viewing history until it receives an indication from the video receiving unit that the video episode has been played on the video receiving unit in its entirety.

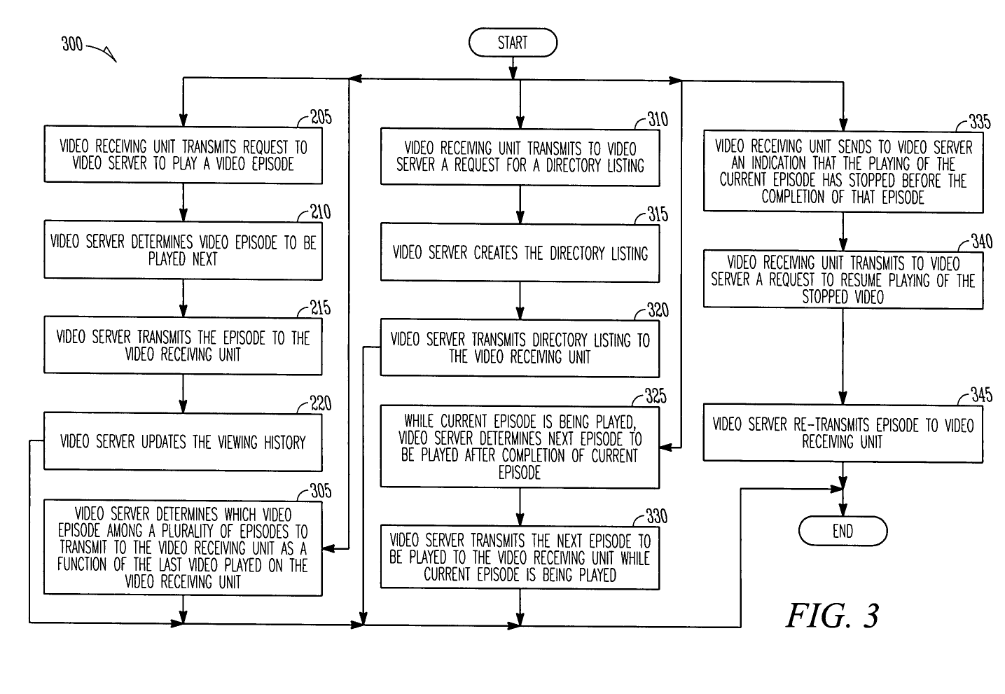

FIG. 3 illustrates another example embodiment of a process 300 that determines which video episode, among a plurality of related episodes, is to be played next on a video receiving unit. The process 300 includes the steps 205, 210, 215, and 220 of the process 200 of FIG. 2, plus additional steps. It is noted that not all the steps of process 300 may be executed in any one embodiment, and the steps that are executed in any one embodiment may be in an order different than that depicted in FIG. 3. In one embodiment, at 305, the video server determines which video episode among the plurality of episodes to transmit to the video receiving unit as a function of the last video episode played on the video receiving unit.

At 310, the video receiving unit transmits to the video server a request for a directory listing of video episodes. At 315, the video server creates the directory listing of video episodes as a function of at least one video episode formerly played on the video receiving unit. After the video server creates the directory listing, the video server at 320 transmits the directory listing to the video receiving unit. If the request from the receiving unit contains a user identifier of some type, then the video server can create a personalized directory associated with that user identification.

At 325, the video server determines, while a current episode is being played on the video receiving device, the next episode that should be played on the video receiving device after the current episode has completed. At 330, the video server transmits that next episode to the video receiving unit. In an embodiment, that next episode is transmitted to the video receiving unit while the current video episode is still being played, so that that next video episode is ready for playing on the video receiving unit immediately after the current video episode is complete.

Another embodiment is outlined in steps 335, 340, and 345. At 335, the video receiving units sends to the video server an indication that the playing of the current episode on the video receiving unit has stopped before the completion of that episode. The video receiving unit also transmits an indication of where in the episode that the playing of the episode has stopped. Sometime thereafter, at 340, the video receiving unit transmits to the video server a request to resume the playing of the episode that was prematurely halted. At 345, the video server transmits the episode to the video receiving unit. The re-transmitted episode is marked to indicate where the video receiving unit should resume playing of the episode. In another embodiment, the video server transmits only the portion of the episode that has not been played, thereby conserving bandwidth in the system.

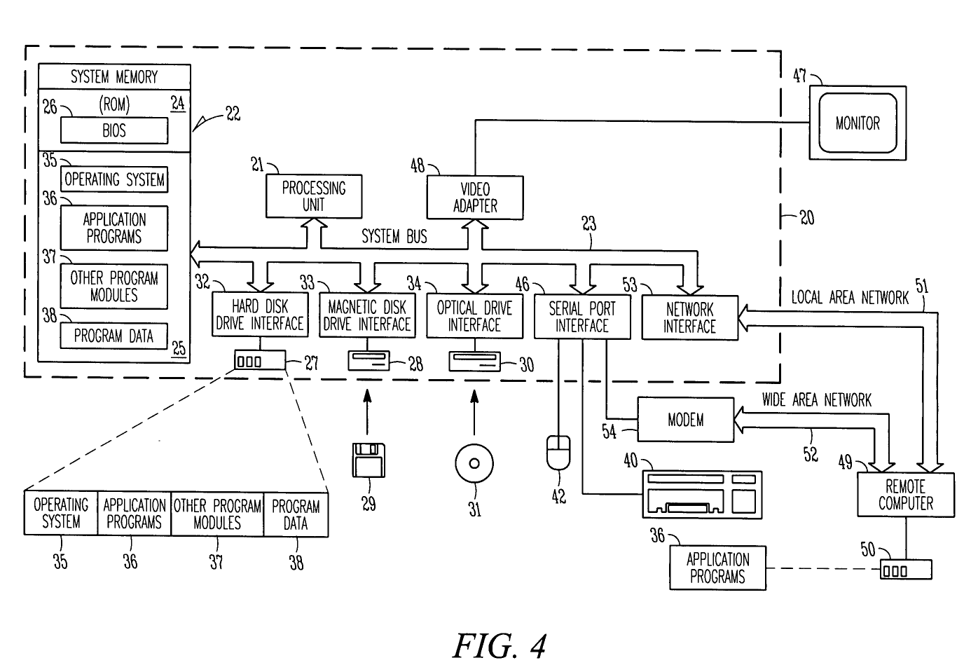

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 2 1, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the examples in the disclosure are not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

In the foregoing detailed description, various features are grouped together in one or more examples or examples for the purpose of streamlining the disclosure. This method of disclosure is not to be interpreted as reflecting an intention that the claimed examples of the invention require more features than are expressly recited in each claim. Rather, as the following claims reflect, inventive subject matter lies in less than all features of a single disclosed example. Thus the following claims are hereby incorporated into the detailed description as examples of the invention, with each claim standing on its own as a separate example. It is understood that the above description is intended to be illustrative, and not restrictive. It is intended to cover all alternatives, modifications and equivalents as may be included within the scope of the invention as defined in the appended claims. Many other examples will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A video server comprising a configuration to:
receive from a video receiving unit a request to transmit a video episode;
determine from a viewing history the video episode, out of a plurality of related and sequential video episodes, to transmit to the video receiving unit; and
transmit the video episode to the video receiving unit.

2. The video server of claim 1, further comprising a configuration to update the viewing history as a function of the video episode transmitted.

3. The video server of claim 1, wherein the determination of the video episode to transmit is a function of a video episode last played on the video receiving unit.

4. The video server of claim 1, wherein the viewing history is associated with a particular person, thereby serving as a personalized viewing history for the particular person.

5. The video server of claim 1, further comprising a configuration to update the viewing history when the video episode transmitted to the video receiving unit has been played in its entirety on the video receiving unit.

6. The video server of claim 1, further comprising a configuration to:
receive from the video receiving unit a request for a directory listing;
create the directory listing as a function of at least one video episode formerly played on the video receiving unit; and
transmit the directory listing to the video receiving unit.

7. The video server of claim 6, wherein the directory listing is associated with a particular person, thereby serving as a personalized directory for the particular person.

8. The video server of claim 1, wherein the video receiving unit includes a mobile unit.

9. The video server of claim 1, wherein the video server includes an Internet Protocol Television (IPTV) server and the video receiving unit includes an IPTV set top box (STB).

10. The video server of claim 1, further comprising a configuration to:
determine a next episode to be played after a current episode is played on the video receiving unit; and
transmit the next episode to be played to the video receiving unit such that the next episode to be played is ready for playing on the video receiving unit immediately after the completion of the current episode.

11. The video server of claim 1, further comprising a configuration to:
receive an indication from the video receiving unit that a playing of the video episode on the video receiving unit has stopped before the end of the video episode and an indication of a point in the video episode at which the playing of the video episode stopped;
receive a request from the video receiving unit to resume playing the video episode; and
transmit the video episode to the video receiving unit such that the video episode is played starting at the point at which the playing of the video episode stopped.

12. The video server of claim 1, wherein the sequential video episodes comprise a series of contiguous video segments.

13. A Set Top Box (STB) comprising a configuration to:
send to a video server a request to transmit a video episode to the STB;
receive the video episode from the video server; and
display the video episode on a display unit associated with the STB;
wherein the video episode is an episode of a plurality of related and sequential episodes.

14. The STB of claim 13, further comprising a configuration to send to the video server a command to update a viewing history when the video episode has been played on the display unit in its entirety.

15. The STB of claim 13, further comprising a configuration to display a directory listing, wherein the directory listing is a function of at least one video episode previously displayed on the display unit.

16. The STB of claim 15, wherein the directory listing is associated with a particular user.

17. The STB of claim 13, further comprising a configuration to:
receive from the video server a video episode to be played after a current video episode is played on the display unit; and
play the received video episode on the display unit immediately after the playing of the current video episode.

18. The STB of claim 13, further comprising a configuration to:
transmit to the video server an indication that a playing of the video episode has stopped before the end of the video episode;
transmit to the video server a request to continue viewing the video episode;
receive from the video server the video episode; and
play the video episode on the display unit starting at a point in the video episode at which the previous playing of the video episode stopped.

19. A personal wireless mobile communication device comprising a configuration to:
send to a video server a request to transmit a video episode to the personal wireless mobile communication device;
receive the video episode from the video server; and
display the video episode on a display unit associated with the personal wireless mobile communication device;
wherein the video episode is an episode of a plurality of related and sequential episodes.

20. The personal wireless mobile communication device of claim 19, further comprising a configuration to send to the video server a command to update a viewing history when the video episode has been played on the display unit in its entirety.

21. The personal wireless mobile communication device of claim 19, further comprising a configuration to display a directory listing, wherein the directory listing is a function of at least one video episode previously played on the display unit.

22. The personal wireless mobile communication device of claim 21, wherein the directory listing is associated with a particular user.

23. The personal wireless mobile communication device of claim 19, further comprising a configuration to:
receive from the video server a video episode to be played after a current video episode is played on the display unit; and
play the received video episode on the display unit immediately after the playing of the current video episode.

24. The personal wireless mobile communication device of claim 19, further comprising a configuration to:
transmit to the video server an indication that a playing of the video episode has stopped before the end of the video episode;
transmit to the video server a request to continue viewing the video episode;
receive from the video server the video episode; and
play the video episode on the display unit starting at a point in the video episode at which the previous playing of the video episode stopped.

25. A machine readable medium including instructions that when executed by a machine execute a process comprising:
sending to a video server a request to transmit a video episode to a personal wireless mobile communication device;
receiving the video episode from the video server; and
displaying the video episode on a display unit associated with the personal wireless mobile communication device;
wherein the video episode is an episode of a plurality of related and sequential episodes.

26. The machine readable medium of claim 25, further comprising instructions for:
sending to the video server an indication that the video episode has been viewed in its entirety; and
updating a viewing history associated with the personal wireless mobile communication device.

27. The machine readable medium of claim 25, further comprising instructions for displaying a directory listing of video episodes, wherein the directory listing of video episodes is a function of a viewing history.

28. The machine readable medium of claim 27, wherein the directory listing of video episodes is associated with a particular user.

29. The machine readable medium of claim 25, further comprising instructions for:
receiving a next video episode to be played on the display unit after a current video episode is played on the display unit; and
playing the next video episode immediately after the current video episode is played in its entirety.

30. The machine readable medium of claim 25, further comprising instructions for:
transmitting to the video server an indication that a playing of the video episode has stopped before the end of the video episode;
transmitting to the video server a request to continue viewing the video episode;
receiving from the video server the video episode; and
playing the video episode at a point in the video episode at which playing of the video episode previously stopped.
